(19) United States
(12) Patent Application Publication
(10) Pub. No.: US 2025/0334694 A1
(43) Pub. Date: Oct. 30, 2025

(54) ROTATING ULTRASONIC FIELD OF VIEW HAVING FIXED SENSOR

(71) Applicant: INVENSENSE, INC., San Jose, CA (US)

(72) Inventor: Joe Youssef, Noyarey (FR)

(21) Appl. No.: 18/647,350

(22) Filed: Apr. 26, 2024

(51) Int. Cl. G01S 17/42; G01S 7/521; G01S 17/04

(52) U.S. Cl. CPC G01S 17/42; G01S 7/521; G01S 17/04

(57) ABSTRACT

Systems and methods of employing a non-rotating sensor to provide a rotating ultrasonic field of view (fov) are provided. A system comprising a processing unit, a fixed ultrasonic sensor, a motor, a bent horn, and appropriate gearing allow for use of a single-direction ultrasonic sensor in providing a fov that may approach or equal 360 degrees. An ultrasonic sensor may have its signal directed along an axis. A bent horn may be rotated about the axis, with a first opening of the horn substantially maintaining its position in front of the sensor and about the axis, such that sensor-emitted signals are received in the first opening and emitted from a second opening that is rotating about the axis. The signals are preferable emitted from the horn in directions that are substantially perpendicular to the axis, and echoes returned from objects in a fov surrounding the axis.

### CROSS REFERENCE TO RELATED APPLICATIONS

None

### TECHNICAL FIELD

The subject disclosure relates to enhancing and expanding the field of view for a single ultrasonic sensor.

### BACKGROUND

Various types of sensors, including lidar, camera, and radar are deployed on autonomous robots to sense the presence and position of objects relative to one or more autonomous robots. These autonomous robots may include vacuum cleaners, automated lawnmowers, robot assistants, delivery robots, and may even include larger robots such as self-driven cars, boats, or aerial robots. These various types of sensors may have undesirable limitations and cost constraints. Lidar may not detect glass objects. Cameras may have dead angles or limited field of view. Cameras may also be sensitive to the lighting conditions. The signals emitted from radar might not reflect on wood. Various types of sensors may have higher cost than is desirable.

Existing ultrasonic sensors may be able to detect the presence of an object in proximity to the sensor, but a single sensor may not be able to locate an object. Rather, multiple sensors may be needed to triangulate the position of an object by taking readings on the distance of the object from different positions. Locating an object in a two-dimensional plane may require two or more sensors for triangulation, while locating an object in a three-dimensional volume may require three or more sensors for triangulation. And when two different objects are returning echoes to an ultrasonic sensor, triangulation techniques may fail.

Accordingly it is desirable to provide alternative sensor systems and methods that may be used to overcome many of these limitations.

### SUMMARY

The following presents a simplified summary of the invention to provide a basic understanding of some aspects of the specification. This summary is not a complete overview of the specification, but should be read in concert with the other portions of this specification to understand the inventive systems and methods disclosed herein.

A sensor may be provided using sonic emissions and echoes, preferably in the ultrasonic range, to detect objects in a manner similar to certain radars or other sensors. Such sensors may employ frequencies at or near 180 KHz, 80 KHz, 50 kHz, or 40 kHz ranges, or other frequencies preferably in the ultrasonic range. Lower frequencies generally transmit longer distances than higher frequencies, so lower frequency sensors are preferable for longer detection ranges with appropriately sized horns. Such a sensor may be placed on top of or otherwise attached to a moving or stable object such as a robot, vehicle, or other suitable mount. Such mounts could include items such as walls, doors, ceilings, windows, or other construction elements in circumstances where it may be desirable to detect or track nearby objects.

Robot navigation and autonomous navigation/environment discovery may be enhanced by use of the inventive systems and methods.

Such sensors may be used to detect objects based on “time of flight” of an ultrasonic pulse and the resulting ultrasonic echo in conjunction with a pulse emission direction, through the use of polar coordinate geometry. A bent horn with a waveguide may be used to focus or deviate ultrasonic pulses emitted from a transceiver, such that the pulses are emitted largely directionally, rather than in a hemispherical or potentially substantially omnidirectional wave. And while a static horn may focus pulses in a single direction or field of view, the inventive system and method provide a bent horn that rotates about an axis that is preferably substantially parallel to an average or mean axis of emission of ultrasonic pulses from a transceiver's acoustic port. In all embodiments of the invention herein, it is preferable to rotate a bent horn about an axis of rotation while the ultrasonic transceiver remains in what can be described as a relatively fixed position. The ultrasonic transceiver(s) may, of course, change position with movement of the object or vehicle to which the transceiver is fixed, but it is not desirable to construct a system in which the transceiver is rotating, due to the complexities of power, control, and data transmission that would occur with a rotating transceiver.

Such a bent horn can be formed to alter the primary direction of travel of pulses and returning echoes by approximately 90 degrees, such that a field of view of the rotating horn will be largely planar. Alternatively, a horn might alter the direction by another angle, which may result in a conical field of view. Alternatively, a horn might be configured to redirect the pulses into a fan-shaped emission (e.g., in the shape of a quarter circle, ⅓ circle, or approaching a semicircle) that, when rotated, could simultaneously detect objects lying (a) within, (b) significantly above, and (c) significantly below a plane that is perpendicular to the horn's axis of rotation. Such a configuration could be useful for sensors on long-height, short-width systems (e.g. towers or streetlights), or long-width, short-height system (e.g., a freight train) about which it is desirable to have an extended field of view in the larger dimension, assuming an axis of rotation of the horn that aligns with the larger dimension.

In such systems, the speed of rotation of the horn can be adjusted such that it rotates slowly, quickly, or even varies in speed depending on various factors such as angular position, past object detect, speed of vehicle on which the horn is mounted, or other factors. A rotating horn mounted on a vehicle moving at 50 mph might need to rotate faster than a horn mounted on a vehicle moving at 5 mph, depending on the desired detection quality and desired refresh rate, as well as the sensor's range and other factors that may be specific to a given application. Expected movement speed of objects in the vicinity might also influence the desired speed of rotation; for example, a system configured to detect or track tortoises might not need to rotate as quickly as a system configured to detect or track hares. It is preferable to rotate (or spin) the horn as quickly as possible within the computational and mechanical abilities of the system, but optimization of other parameters such as power consumption, accuracy, or other concerns might require a slower rotation. And when detecting items at longer ranges, the speed of sound might influence the speed of rotation, as the horn position will need to accommodate both pulses and returning echoes. Thus, the horn should not rotate so quickly that returning echoes within the desired range cannot be received by the horn.

Thus, various embodiments of the inventive systems and methods may encompass features such as those set forth herein.

Certain embodiments may include systems having horns, waveguides, and rotation means. A rotatable bent horn may be provided. The horn may have a mouth opening providing a field of view when rotated, as opposed to merely a single direction of view when not rotated. At the opposite end of the horn (acoustically), a throat opening provides another means for ultrasonic pulses and echoes to enter or exit the horn. Within the horn, a waveguide may preferably be provided to redirect ultrasonic pulses and echoes. Horns may take various configurations, such as configurations similar to those shown in the FIGS. herein, snail configurations, or other configurations, and the horn may be designed in a manner that alters the angular resolution and/or maximum range of detection. The waveguide may be configured to both (a) redirect ultrasonic pulses that were received in the horn's throat opening from a first axis of travel to a second axis of travel prior to emission from the mouth opening and (b) redirect one or more ultrasonic echoes received in the horn's mouth opening from a third axis of travel to a fourth axis of travel prior to emission from the throat opening. This may correspond to pulses being emitted from a transceiver's acoustic port in a direction of travel primarily along a first axis, before encountering the waveguide and being redirected into a potentially perpendicular direction for travel through and from the horn, where the potentially perpendicular direction may correspond to the second axis. While some echoes may return along exactly the same axis, it is not expected that the return axis will exactly match the emission axis, so the return axis may be described as a third axis that may or may not be substantially parallel to the second axis. While travelling through the horn, the echoes will encounter the waveguide and be redirected toward the throat of the horn and the port of the ultrasonic transceiver.

The system may include one or more motors and appropriate linkages (e.g., belts, gears, oscillating drives, screw drives, etc.) for rotating the horn about an axis of rotation. Such motors may include stepper motors, actuators that may be driven to a particular angle, DC motors with angular encoders, brushless DC motors with angular control, etc. An important feature is the ability to understand the angular rotation of the horn at a given time (or at many times), which can often be provided by a motor that provides angular feedback to a control system or rotates only in conjunction with control signals specifying the angle to which the motor should rotate. In systems employing gears or other drive mechanisms, it may be necessary to calculate the angular rotation of the horn based on gear ratios or other drive ratios that rotate the horn at a faster or slower angular rate than the motor's rotation.

In such systems and related methods, it is preferable to rotate the horn in a manner that maintains the throat opening of the horn very close to (or in contact with) the acoustic port of an ultrasonic transceiver, such that ultrasonic pulses are transmitted directly from port to horn and such that ultrasonic echoes are transmitted directly from horn to port. In general, this means that it is desirable to have an axis of rotation for the horn that passes through both the acoustic port and the throat to maintain alignment between the two. Having such an arrangement may make direct drive of the horn and its housing difficult, because a drive shaft might be required to pass through the throat and/or port. As such, the drive mechanisms described herein avoid interference with the port and throat. Alternatively, the horn may be driven by an attachment that is opposite the throat, while allowing the axis of rotation to pass through both the throat and port.

In many embodiments, it is desirable to maintain the ultrasonic transceiver in a substantially fixed position with respect to the axis of rotation. This does not mean that the transceiver cannot move. For example, if an inventive system including a transceiver is attached to an automobile or other vehicle, it is obvious that both the transceiver and the axis of rotation will move with the vehicle. If the vehicle traverses a windy road or drives in a circle, the transceiver will, likewise, wind through the road or travel in a circle. For purposes of this disclosure, the substantially fixed position of the transceiver is understood to remain substantially fixed with respect to the axis of rotation, even while traveling, winding, or circling on a vehicle.

Rotation of many horns in such systems will result in the mouth opening tracing or traversing a substantially circular arc-shaped path with respect to the axis of rotation that could be said to lie on a plane that is perpendicular to the axis of rotation. It is expected that, in a mechanical system, some wobble might occur that might make the path less than perfectly planar. And, in certain embodiments using a snail shaped horn, it is possible that the mouth of the horn may be directly above the port such that the axis of rotation passes through the mouth of the horn while it is rotating; in such embodiments, only portions of the mouth of the horn would traverse such a path, while the portion of the mouth on the axis of rotation would not traverse a path but merely rotate in place.

Many preferred embodiments will include an ultrasonic transceiver. Such a transceiver will preferably be configured to transmit ultrasonic pulses and receive ultrasonic echoes. Often such pulses and echoes travel through an acoustic port in the transceiver, though it is possible to construct transceivers that do not require a port.

It is desirable in many embodiments to position the transceiver near the horn's throat opening. Such positioning will allow a substantial portion of the ultrasonic pulses transmitted by the transceiver to be directed into the throat opening. And such positioning will also allow resulting ultrasonic echoes to be received by the transceiver from the horn's throat opening. As noted above, because a rotating transceiver may pose difficulties with respect to transmitting power, control signals, or data, in many embodiments the transceiver is arranged to maintain a substantially fixed position with respect to rotation about the axis of rotation when the horn is rotated about the axis of rotation.

In many embodiments, it will be desirable to configure the waveguide of the horn to redirect the ultrasonic pulses into a direction that is substantially perpendicular to the axis of rotation. Similarly, it will be desirable to configure the waveguide of the horn to redirect the ultrasonic echoes into a direction that is substantially parallel to the axis of rotation. It is understood that ultrasonic pulses (and echoes) travel from a point and spread in a generally spherical manner, and that when such pulses or echoes travel through a generally circular mouth of a horn, they may be in the form of a spherical cap or similar shape. Thus, in this disclosure where reference is made to a direction of travel, it is understood that the pulse or echo may be expanding in various directions, so the direction of travel is intended to refer to a primary or significant direction in which the pulse or echo is travelling.

Many embodiments will include a processor, such as a microprocessor, a CPU, a navigation system processor, a controller, or other forms of processors that can receive data regarding angle of rotation at various times and receive sensor data regarding ultrasonic echoes. The data regarding angle of rotation need not be data indicating the angle of rotation itself, but other data from which the angle of rotation can be computed. For example, such data might include the angle of the motor, the position of one or more gears (possibly obtained by an optical counter), the period of rotation combined with the speed of rotation, or other data from which the horn's angle can be determined and related meaningfully to the receipt of ultrasonic echoes. In many embodiments, it will be desirable for the transceiver to provide sensor data to the processor. This can include range data based on receipt of echoes, data related to times of pulses and echoes, data related to different frequencies of pulses or echoes, data related to functionality of the transceiver, or other data that may be of use in determining the environment in which the sensor system resides. In the simplest form, the transceiver can provide range data directly to the processor, so that the processor can tie an angle to a range and determine the location of a detected object. However, in various embodiments, it might be desirable to provide other forms of data. The processor is preferably configured to do at least one and potentially numerous types of calculations to process the meaning of data provided with respect to rotation and the ultrasonic sensor, including using the angle of rotation data and the sensor data to detect and locate objects in proximity to the horn.

In certain embodiments, the motor may be configured (e.g., controlled or mechanically designed) to rotate the horn in an oscillating manner about the axis of rotation such that the horn rotates less than 360 degrees about the axis of rotation before reversing the direction of rotation. An oscillating system of this type proceeds back and forth in a field of view and can provide a more comprehensive view of and faster updates to a field of view that is in an angular range that is smaller than 360 degrees.

While embodiments of the invention may find success in locating an object by emitting only a single ultrasonic pulse from the horn, it is preferably to emit multiple ultrasonic pulses from the transceiver acoustic port and from the horn mouth. Such pulses may be emitted at a regular interval or at irregular intervals, which may be adjusted according to the purpose of a particular system and environment in which it might be expected to operate. In some embodiments, it might be desirable to quickly emit successive pulses, while in other embodiments, it might be desirable to emit pulses less quickly. The echoes of these pulses are preferably received by the mouth of the horn so that the system may be able to determine an object location based on the position that the mouth had when the pulse was emitted (or when the pulse's echo was received). In this manner, with a plurality of pulses and echoes, it is possible to determine the location of a plurality of objects in the field of view.

Certain embodiments of the invention may take the form of computer executable instructions fixed on a non-transitory machine-readable medium. Such instructions may provide control for the various steps and processes described herein. As one example, software may be fixed on a medium such as flash memory, an optical disc, a server on a communication network, etc. that will cause performance of the steps of one or more embodiments of the invention when executed by a processor.

The following description and the annexed drawings set forth certain illustrative example implementations and embodiments of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

The numerous aspects, embodiments, objects and advantages of the present disclosure will be apparent upon consideration of the following detailed description, taken in conjunction with the accompanying drawings, in which like reference characters refer to like parts throughout, and in which:

FIG. 1 is a block diagram of an embodiment of a sensor in accord with the current invention.

FIG. 2 is a side view of a block diagram of certain components of a partially disassembled embodiment of the current invention.

FIG. 3 is a side view of a block diagram of certain components of a partially disassembled embodiment of the current invention.

FIG. 4 is a side view of a block diagram of certain components of an embodiment of the current invention.

FIG. 5 is a perspective view of certain components of an embodiment of the current invention.

FIG. 6 is a combined block and perspective view of an embodiment of the current invention.

FIG. 7 is a perspective view of the outer portion of a housing in accordance with aspects of the current invention.

FIG. 8 is a perspective view of the inner portion of a housing in accordance with aspects of the current invention.

FIG. 9 is a perspective view of an embodiment of a sensor on a PCB in accordance with aspects of the current invention.

FIG. 10 is an overhead view of a block diagram of certain components of an embodiment of the current invention.

FIG. 11 is an overhead view of a block diagram of an embodiment of a potential display layout for use with the invention.

FIG. 12 is an overhead view of a block diagram of certain components of an embodiment of the current invention, illustrating an interaction of the current invention with an object as well as an embodiment of a potential display layout for use with the invention.

FIG. 13 is an overhead view of a block diagram of certain components of an embodiment of the current invention, illustrating an interaction of the current invention with an object as well as an embodiment of a potential display layout for use with the invention.

FIG. 14 is an overhead view of a block diagram of certain components of an embodiment of the current invention, illustrating an interaction of the current invention with an object as well as an embodiment of a potential display layout for use with the invention.

FIG. 15 is an overhead view of a block diagram of certain components of an embodiment of the current invention, illustrating an interaction of the current invention with an object as well as an embodiment of a potential display layout for use with the invention.

FIG. 16 is an overhead view of a block diagram of certain components of an embodiment of the current invention, illustrating an interaction of the current invention with an object as well as an embodiment of a potential display layout for use with the invention.

FIG. 17 is an overhead view of a block diagram of certain components of an embodiment of the current invention, illustrating an interaction of the current invention with an object as well as an embodiment of a potential display layout for use with the invention.

FIG. 18 is a perspective view of certain components of an embodiment of the current invention.

### DETAILED DESCRIPTION

One or more embodiments and/or implementations are now described with reference to the drawings, wherein like reference numerals are used to refer to like elements throughout. In the following description, for purposes of explanation, numerous specific details are set forth in order to provide a thorough understanding of the various example implementations and/or embodiments. It may be evident, however, that the various example embodiments and/or implementations can be practiced without these specific details. In other instances, well-known structures and devices are shown in block diagram form in order to facilitate describing the embodiments and/or implementations in additional detail.

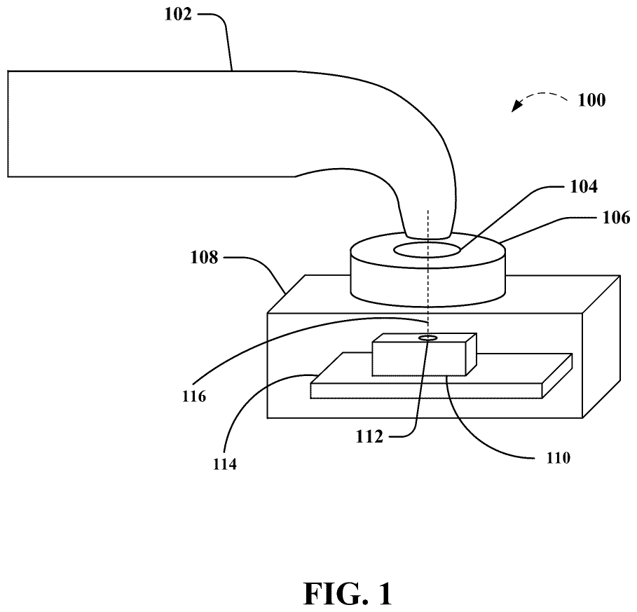

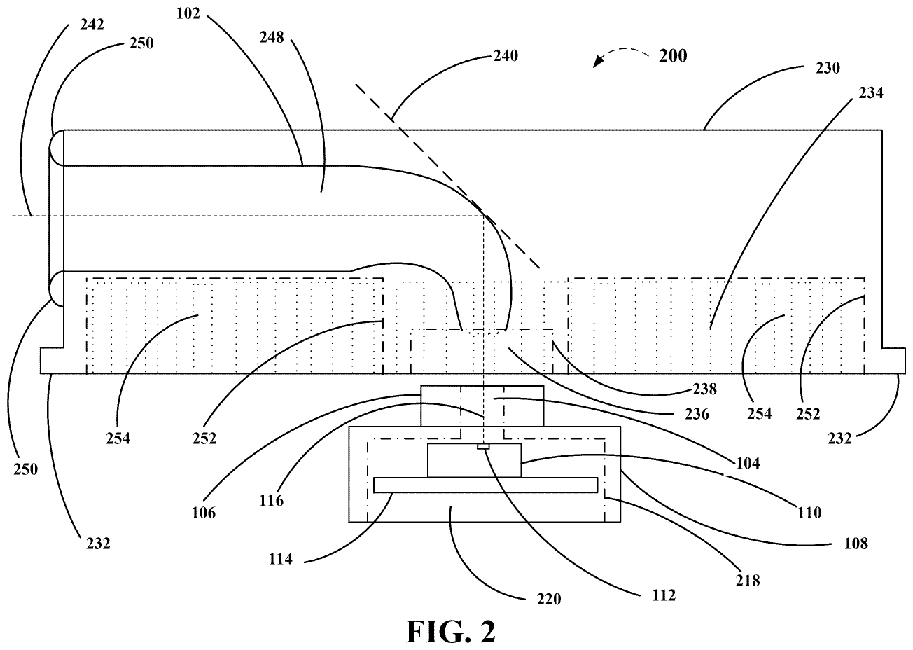

In FIG. 1, a system 100 is illustrated in block form to illustrate certain of the features of the present invention in at least one embodiment. A bent horn 102 is provided, having an unlabeled mouth and throat, and is oriented such that pressure waves, such as ultrasonic sound waves, traveling along axis 116 may be transmitted through the horn in either direction and redirected by the waveguide of horn 102, upon reaching the curved portion of the horn. (In general, a horn throat is the horn's opening touching or near the transceiver, while the mouth is the horn's opening that is generally exposed to the environment into which pulses are emitted and from which echoes are received.) A cylindrical orifice 104 provides a passageway through which pressure waves, such as ultrasonic pulses and echoes, traveling along axis 116 may enter and exit the horn 102 while traveling to and from port 112 of transceiver or sensor 110. Cylindrical wall 106 surrounds cylindrical orifice 104 and primarily provides for a preferably cylindrical passage through which ultrasonic pressure waves may travel in either direction. It will often be preferable to form the outer portion of wall 106 in a cylindrical shape, as discussed below with respect to FIGS. 2-4, such that the cylindrical wall 106 may assist with both support and rotation of horn 102, as well as, preventing lateral movement of the throat of horn 102 away from the cylindrical orifice 104, while simultaneously allowing the mouth of horn 102 to be rotated about an axis that aligns substantially with axis 116.

The embodiment of horn 102 depicted herein is one of multiple options for an acoustic horn that may be used with the inventions set forth herein. Other horn configurations may include, for example, snail horns or exponential horns, provided that an appropriately directional nature of pulse emission and echo receipt may be implemented with such horns.

Enclosure 108 may be mechanically coupled to cylindrical wall 106 and may form an enclosure to protect transceiver or sensor 110 and carrier 114, which may be a PCB, from external influences such as liquids, impacts, or other detrimental encounters. The carrier 114 may be sized and positioned so as to form a seal for the bottom of enclosure 108 when inserted thereon, comma or may be differently sized or shaped, such that it is small enough to fit within enclosure 108 without sealing it, depending upon the applications for which the system and method are being used. Notably, while an enclosure 108, cylindrical wall 106, and carrier 114 are depicted in this embodiment, various embodiments of the inventive systems and methods could be provided without the need for such components, so long as a bent horn is able to rotate while transmitting ultrasonic pulses and echoes from one axis to another axis. One can construct such systems without placing the transceiver 110 within an enclosure and without requiring the pulses and echoes to travel through a cylindrical orifice 104 before reaching the throat of the horn 102.

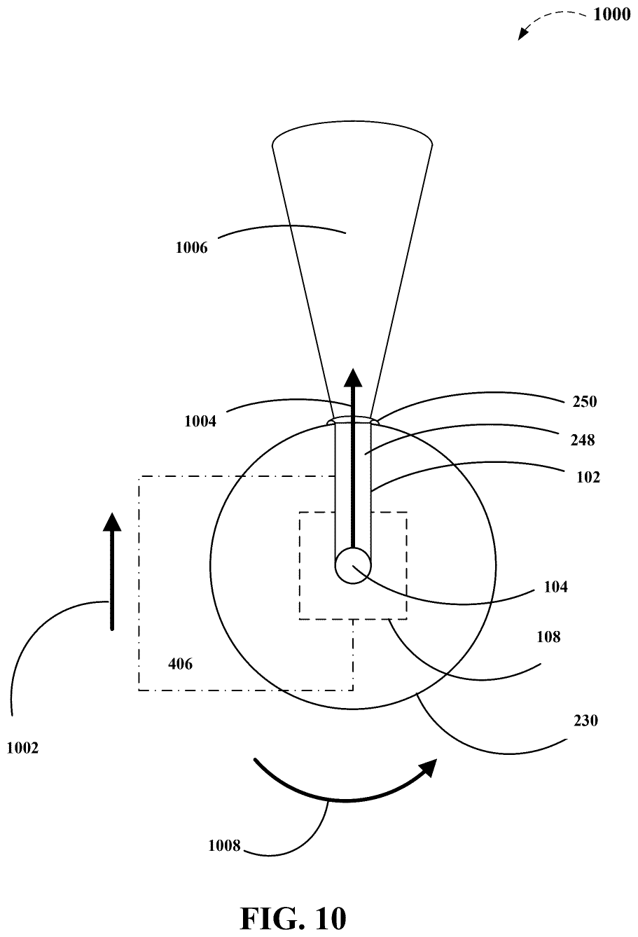

Referring now to FIG. 2, a side view of an embodiment 200 of the current invention is provided in which a housing 230 is provided enclosing the waveguide of bent horn 102. The housing 230 in this embodiment preferably has a cylindrical outer shape such that when viewed from above, housing 230 will be circular as depicted below (e.g., FIG. 10). It is possible to provide a non-cylindrical housing 230, so long as the device is constructed in a manner that allows rotation of horn 102 such that ultrasonic pulses may be broadcast in a manner that sweeps across a field of view. For example horn 102 and its waveguide may be set upon a rotatable disc without forming a housing 230 about all or portions of horn 102 in alternative embodiments of the inventive system and method.

In the embodiment depicted in FIG. 2, enclosure 108 is depicted below housing 230 such that cylindrical wall 106 is not disposed within cylindrical orifice 236. Cylindrical orifice 236 is bounded by walls 238 depicted with a dot-dash line while remaining fully open on the bottom and partially open on the top (in the depicted orientation). Orifice 238 includes a top opening to the throat of horn 102, into cavity 248 within the horn 102 such that a contiguous open space extends from the mount of horn 102 at toroidal rim 250 to the throat of horn 102 at top wall 238. The opening at the bottom of orifice 238 allows for insertion of cylindrical wall 106 into cylindrical orifice 238 such that cylindrical orifice 104 may align with the throat of Horn 102 for transmission of ultrasonic pulses and echoes along axis 116. Pulses may originate from port 112 of transceiver 110, travel along axis 116 through cavity 248 comma until encountering a wall of the horn's waveguide, whereupon the pulses may be deflected by the wall and travel along a path that is similar to a second axis 242 until emerging from the mouth of the horn 102 within toroidal rim 250.

Adjacent to toroidal rim 250, as depicted in FIG. 2, an axis or plane 240 is depicted with a dashed line. If 240 depicts a plane, it is a plane that is perpendicular to the page on which this image is printed. Axis or plane 240 provides an approximation of the general angle of the wall that is preferred for deflection of the ultrasonic pulses from axis 116 to axis 242 in a system or method wherein a deflection of approximately 90 degrees is preferred. In such embodiments, it is preferable to provide an approximate 45° angle to axis 116 in the wall of cavity 248 that is tangential to axis or plane 240 such that the ultrasonic waves will be deflected at approximately a 90° angle from axis 116 onto axes substantially aligned with axis 242 and when echoes are returned along axis 242 or similar axes such that the echoes encounter the same wall of cavity 248 that is depicted as tangential to axis or plane 240, those returning echoes will be deflected by approximately a 90° angle and directed in the direction indicated as downward in FIG. 2, along axis 116 or similar axes. Such waves will pass through the throat horn 102 at the point where cavity 248 meets upper wall 238, into cylindrical orifice 104, and ultimately arrive at port 112 where the echoes can be read by the transceiver 110 and the time of arrival noted by appropriate circuitry.

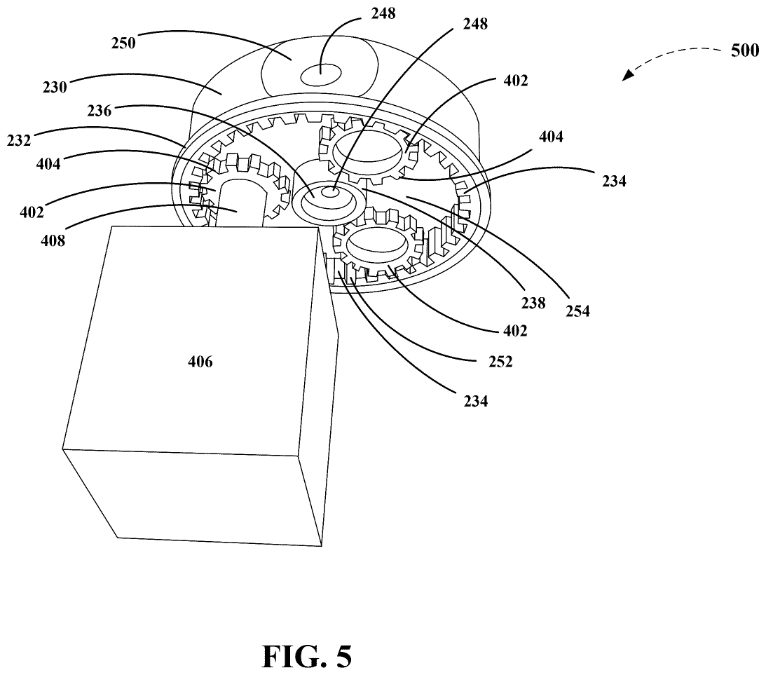

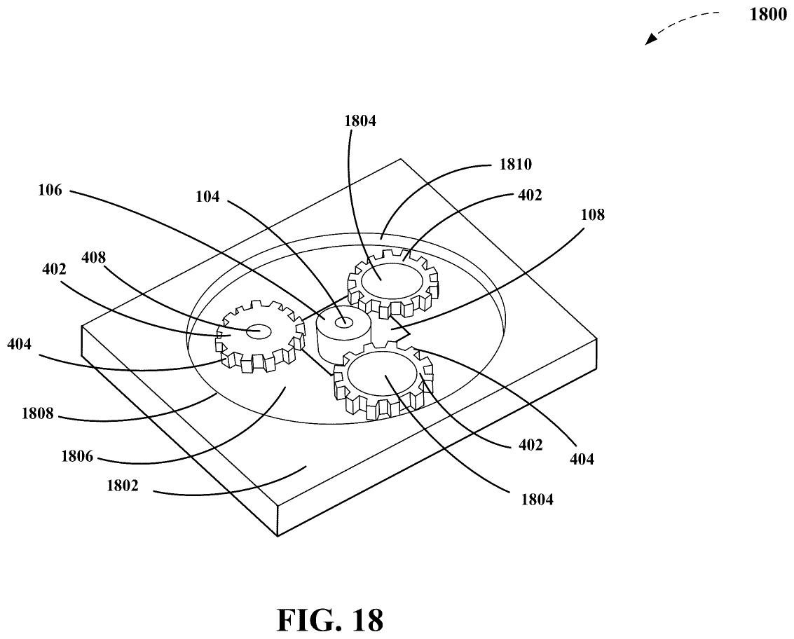

As depicted in FIG. 2, the mouth of horn 102 may be defined by a toroid rim 250 that provides a softer edge to the mouth into cavity 248 such that returning echoes may be more accurately received and read. Also within housing 230 are dotted lines indicating a series of teeth 234 (see FIG. 5) within a cylindrical cavity 254 that extends about the interior circumference of the outer wall of Housing 230 and is defined by walls 252 (depicted in cutaway form here). Such teeth 234 will be depicted in later figures (e.g., FIG. 5) in more detail and may be used to engage with gears 402 (not shown in FIG. 2) to both stabilize and rotate housing 230 about an axis of rotation that is preferably substantially parallel to axis 116. Also depicted is rim 232, a circular rim about the exterior circumferential perimeter of housing 230. Rim 232 may be used to position or lock housing 230 onto a substrate (e.g. housing 1802 in FIG. 18) or within a depression within a substrate (e.g., recessed portion 1806 of housing 1802 in FIG. 18) to permit free rotation about the axis of rotation while preventing housing 230 from being too easily removed from that substrate (e.g., housing 1802 in FIG. 18). Not depicted are latches of other means of securing the rim to a substrate such as housing 1802, but the rim can be secured by one or more latches or fixed structures that permit rotation while restricting the amount of movement of housing 230 away from enclosure 108 (generally along axis 116, but potentially along or about other axes).

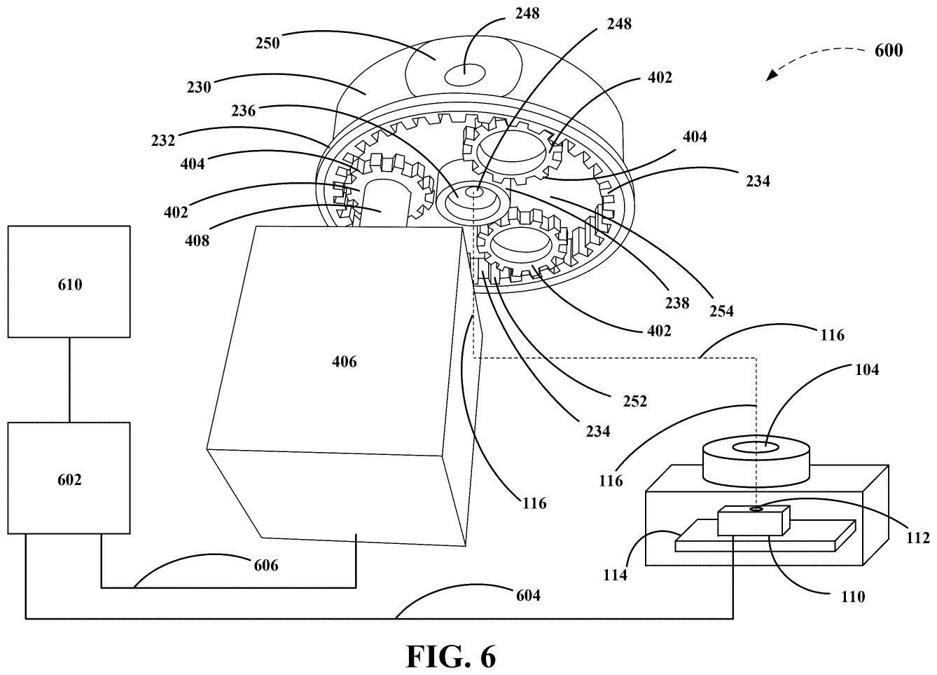

As depicted in FIG. 2, a cutaway view of enclosure 108 shows inner walls 218 defining both a cavity 220 within housing 108 and a circular orifice 104. It's preferable to form these walls 218 such that circular orifice 104 is contiguous with the cavity 220 such that the top of transceiver 110 may be moved through cavity 220 and positioned against the bottom of upper wall 218 so that port 112 is aligned with axis 116 and cylindrical orifice 104 for transmission of ultrasonic pulses and echoes between cavity 248 of horn 102 and port 112. As depicted, transceiver 110 is attached to the top of a carrier 114 that does not, in this depiction, entirely seal cavity 220, but could be formed so that it would seal the lower portion of cavity 220 above carrier 114 (albeit with an opening through orifice 104). It is preferred that when a transceiver 110 is mounted on a carrier 114, the carrier be formed as a PCB to allow the transceiver to be electrically connected through the PCB to external components, such as those referenced in FIG. 6.

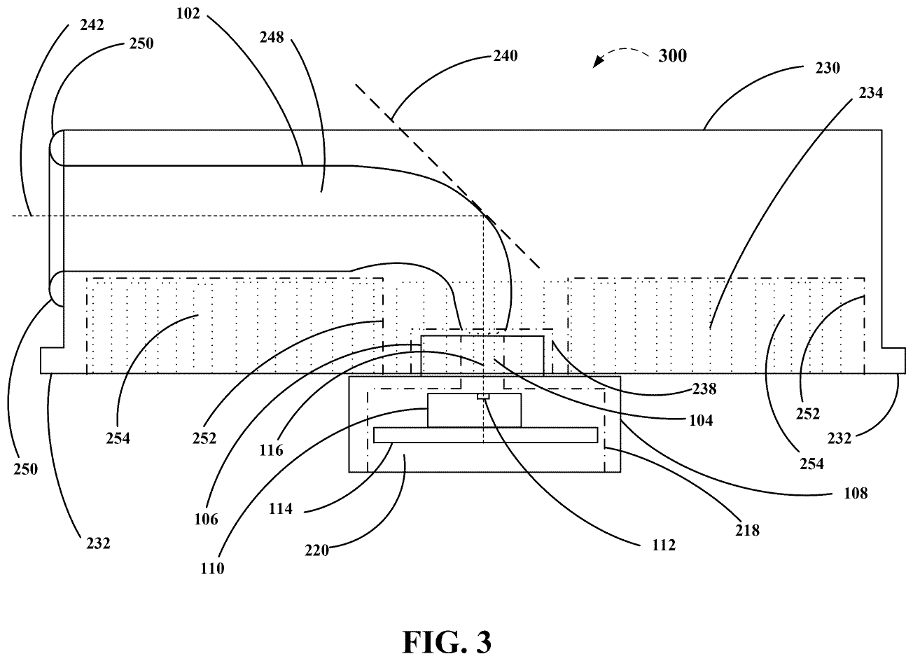

In FIG. 3, system 300 depicts substantially the same embodiment as depicted in FIG. 2. with the exception that in FIG. 3, cylindrical wall 106 is positioned within cylindrical orifice 236 such that the top edge of cylindrical wall 106 is closer to the throat of horn 102 for transmission of ultrasonic pulses and echoes from port 112, along axis 116. This FIG. 3 is simplified to eliminate complexity and does not depict guide rails, bearings, or other means or methods that may optionally be used to reduce friction during rotation of housing 230 relative to enclosure 108 comma, in the event that enclosure 108 or any portion of wall 106 comes into direct contact with housing 230. Such devices may be used and may be desirable in various embodiments of the invention disclosed herein.

Alternative embodiments, not depicted, can be envisioned, in which two transceivers are used and scanning in the same, opposite, or partially offset directions by providing a second set of the components depicted in FIG. 3 in an inverted configuration, sitting on top of housing 230, or even partially integrated therein, so long as the horns can be kept separate. Such a system could be configured with only a single drive mechanism, as it may be desirable for both horns to rotate in concert. Building such a system would likely require a support structure for the upper enclosure 108 (in which the transceiver 110 was positioned with the port 112 directed downward) for electrical and data connections and to maintain both transceivers 110 in a static position with respect to one another.

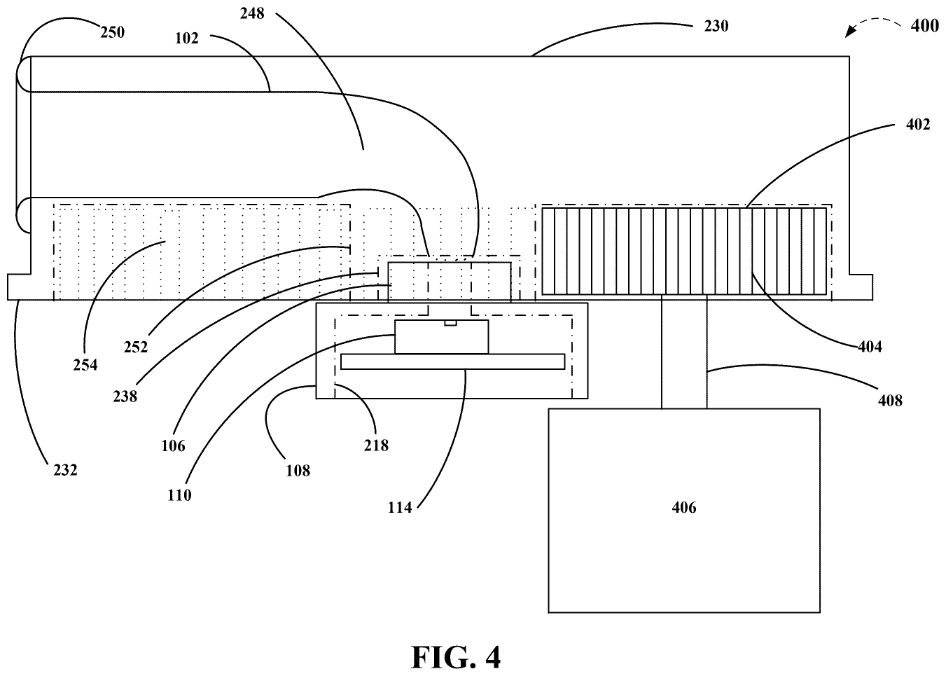

Turning to FIG. 4, system 400 is depicted in largely the same configuration as system 300, except that a motor 406 and drive mechanism have been added to system 400. In system 400, a gear 402 having numerous teeth 404 is preferably driven by motor 406 via a shaft 408. The teeth 404 of gear 402 may engage with the teeth 234 of housing 230 within the perimeter wall of cylindrical cavity 254. As can be seen in FIG. 4, the rightmost portion of cylindrical cavity 254 may be largely filled by gear 402, while the other portions of cavity 254 remain empty, as in this depiction. The diameter of gear 402 may span the majority of one portion of cavity 254 from inner Wall 252 to outer wall 252. A larger gear may be used to achieve a faster rotation of housing 230 given a constant speed of motor 406. Alternatively, a smaller gear 402 would permit a slower rotation of housing 230 given the same motor speed. Various applications may require balancing the angular precision that might be achieved with a smaller gear 402 and slower rotation of housing 230 versus a high speed in sweeping the field of view with a larger gear 402 that results in a faster rotation of housing 230.

FIGS. 5 and 18 depict various components of an embodiment of the invention in a perspective view. System 500 in FIG. 5 depicts the same system 400 that was depicted in FIG. 4, except from a different angle. As can be seen, toroidal rim 250 of housing 230 provides a mouth for horn 102 into cavity 248 within horn 120. The cavity, not depicted in FIG. 5, extends through the housing 230 and, after bending, emerges at the throat, also labeled as the opposite end of cavity 248 within cylindrical orifice 236. The motor 406 is preferably attached via shaft 408 to a single gear 402 having teeth 408 that are engaged with teeth 234 of housing 230 to rotate housing 230 about an axis substantially parallel to axis 116 (not depicted in FIG. 5).

As depicted in FIG. 5, it may be desirable to engage two, three, or more gears within cavity 254 of housing 230. The additional gears can provide stability and also support for housing 230 as it rotates about an axis substantially parallel to axis 116. Each of the gears 402 may be equipped with multiple teeth 404. The gears depicted in FIG. 5 are similar to planetary gears for purposes of stability and distribution of forces, however are not driven by a central gear due to the preferred placement of the port in the center of the housing. However, it would be possible, but likely more complex, to implement a true planetary gear system with the transceiver between a central gear and the horn while being supported by supports anchored between the gears, or potentially by providing a central gear with a port passing through it that is driven by one of the outer gears. Alternative drive arrangements with or without gears (e.g., belt drive, oscillating drive, etc.) without departing from the spirit of the invention. It is possible that the gears may be of different sizes depending upon the alternative needs of a given implementation without departing from the spirit of the invention disclosed herein. Gears or other drive systems may be placed outside of a housing 230, but might encounter debris or damage from impacts that might be partially or fully mitigated through an enclosed drive system such as depicted in FIG. 5.

In FIG. 5, the teeth 234 extend along the entire height of inner wall 252 in cavity 254. It is not necessary that the teeth 234 extend for the entire height of wall 252 and the teeth may, in fact, be shorter than the height of wall 252 if so desired. Central to cylindrical cavity 254 is cylindrical wall 238 that defines cylindrical orifice 236 into which cylindrical wall 106 (not depicted in FIG. 5) may be inserted. As depicted, a portion of motor 406 overlaps the volume in which axis 116 might extend from horn 102, where enclosure 108 might potentially be placed. This is permissible so long as enclosure 106 may be placed in proximity to the opening of cavity 248 within cylindrical orifice 236 as described above. In certain embodiments, cylindrical orifice 236, wall 238, and even enclosure 108 are not necessary for the performance of the inventive methods disclosed herein. Rim 232 is disposed about the exterior wall of housing 230.

Turning to FIG. 18, a system 1800 is depicted having a housing 1802 designed to be placed opposite housing 230, between housing 230 and motor 406. As a point of reference, the three gears 402 depicted in FIG. 5 are also depicted in FIG. 18 disposed on pillars 1804. Pillars 1804 allow two of the gears 402 to be mechanically attached to housing 1802 while also being permitted to freely rotate when motor 406 drives the third gear 402 via shaft 408. This causes teeth 404 to engage with teeth 234 (not depicted in FIG. 18) and rotate housing 230 (also not depicted in FIG. 18). Within housing 1802, a recessed portion 1806 and rim 1808 are defined by a cylindrical wall 1810. Wall 1810 and recessed portion 1806 are preferably sized in proportion to housing 230 and its outer rim 232 such that both the lower portion of the housing 230 and rim 232 may fit within cylindrical wall 1810 when cylindrical wall 106 engages with cylindrical orifice 236 such that cylindrical orifice 104 is adjacent to the throat of horn 102. As can be seen in FIG. 18, enclosure 108 may be inserted into an appropriately sized receptacle that allows it to lie below any gears 402, while cylindrical wall 106 protrudes into recessed portion 1806, and potentially above the level of rim 1808 (depending on the dimensions of the other components of the system).

Referring now to FIG. 6, system 600 depicts housing 230, motor 406, and other components of an embodiment of the invention. Motor 406 may send motor data (including angular data) along data line 606 to processor 602. Transceiver 110 may send sensor data (including time of flight and time of reception data or, possibly, computed distance data) along data line 604 to processor 602. Processor 602 may be configured to compute the locations of objects based on data received, or alternatively to transmit the same data to a navigation system 610. As described herein, it is preferable that the motor data indicate at least an angular position of the housing 230 that corresponds to the direction in which the mouth of toroidal rim 250 is emitting and receiving ultrasonic pulses and echoes from and into horn 102. Such angular data can be used with data regarding the time at which ultrasonic pulses were sent and ultrasonic echoes were received to plot the angular direction and distance of objects within the field of view. Conversion from polar to cartesian coordinates will allow for determination of object positions within an x,y coordinate system if desired. Control data may also be returned along line 604 to transceiver 110 or along line 606 to motor 406. While lines 604 and 606 are depicted in block form as a single line, it is understood that data communication lines may take many forms, may include a plurality of wires, and may even include a shared bus or other known form of communication between subcomponents of a system, including optical, RF, or other forms of communication between components. Various forms of communication between the indicated components may be employed without departing from the spirit of the invention.

In FIG. 6, axis 116 is depicted in a blown up fashion to provide the ability to clearly place various components within the drawings. However, axis 116 (in actual usage) is a straight axis along which an ultrasonic pulse or echo may travel, as depicted in FIG. 1. A person ordinary skill will recognize that when cylindrical orifice 104 is adjacent to the throat of horn 102, as indicated by cavity 248 within cylindrical orifice 236, axis 116 will be a straight line.

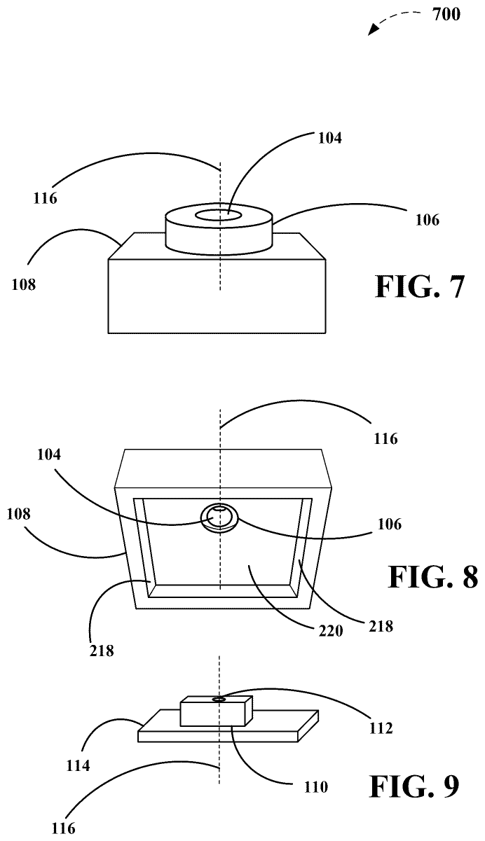

FIGS. 7, 8, and 9 depict components of a system 700 from various angles and with axis 116 depicted separately with respect to each of the components. Both FIG. 7 and FIG. 8 depict projected views of enclosure 108, including cylindrical orifice 104, cylindrical wall 106, and axis 116.

FIG. 8 also depicts interior walls 218 of enclosure 108 that form the bounds of cavity 220 into which transceiver 110 and carrier 114 may be placed.

As depicted in FIG. 9, axis 116 is a line such that when transceiver 110 is inserted into cavity 220, axis 116 will preferably be aligned with cylindrical orifice 104 such that ultrasonic pulses emitted from port 112 may travel through orifice 104 along axis 116 or a similar axis. And ultrasonic echoes returning along the same axis 116 or a similar axis may be received by port 112 after passing through cylindrical orifice 104.

Microelectromechanical system (MEMS) microphones (and/or other transducer type equipment) and MEMS microphone arrays (and/or other arrays of transducer class equipment) can have frequency response extending well into the ultrasonic range (e.g., approaching and greater than about 20 kHz). Such MEMS equipment can allow capture of air pressure variations well into the ultrasonic range, which can enable a multitude of functionality. Functionalities, in various implementations and/or embodiments, can include proximity detection, range-finding, etc. Such functionalities and/or facilities can be achieved, for example, by integration with specifically designed ultrasonic transmitting equipment and/or by using the MEMS equipment itself to perform transmissions into the ultrasonic range.

Range-finding, data transmission, and other ultrasonic functionality may also be performed with purpose-built equipment, like piezoelectric micro-machined ultrasonic transducers (PMUTs) and/or capacitive micro-machine ultrasonic transducers (CMUTs). These purpose-built PMUTs and/or CMUTs have generally been optimized for a band within the ultrasonic range and may be capable of receiving and transmitting ultrasonic frequencies.

A general purpose integrated circuit (IC) and/or an application-specific integrated circuit (ASIC)—an integrated circuit chip configured for a particular use, or downstream processing (e.g., in addition to and/or as an alternative to the general purpose IC and/or ASIC) can initiate ultrasonic transmission and/or reception based on various means. The data that can be gathered and utilized by such activity can comprise: data that can be used to determine range/amplitude to a nearest object. Further data can also comprise a broadcasted ping (and/or sequence of pings) that the MEMS transducer can listen for, wherein the broadcasted ping and/or ping sequences can have been (and/or are being) emitted from one or more external broadcast source (e.g., a transducer similarly configured to that detailed in the subject disclosure, and an external independent ultrasonic transceiver that emits ultrasonic signals).

FIGS. 10-17 depict an overhead view of the inventive system, including a potential layout of a display screen 1206 for data relative to the inventive method, as well as an example of operation of the inventive system and method with respect to an object 1202 that is moving adjacent to the inventive system.

Turning first to FIG. 10, system 1000 depicts an overhead view of a block diagram of the inventive system. At the level closest to the viewer's eye, housing 230 is depicted with toroidal rim 250 and mouth of horn 102 facing in a relative northerly or upward direction on the drawing. The direction in which the horn 102, including mouth defined by toroidal rim 250, is facing is represented by an arrow 1004 directed from cylindrical orifice 104 through the horn 102 and in the primary direction of travel of ultrasonic pulses emitted from transceiver 110 (not pictured in FIG. 10). Enclosure 108 is depicted as a dotted line below housing 230 and motor 406 is depicted as a dot dash line below both housing 230 and enclosure 108. Reference direction 1002 is depicted as an arrow on the left side of the drawing, which may be assigned an arbitrary value such as 0°, north, or any other appropriate system of reference with respect to the orientation of transceiver 110 within enclosure 108. The orientation of direction 1002 is fixed and will not change with respect to transceiver 110. However, if the inventive system 1000 is mounted upon a moving object, such as a vehicle, animal, human, or other moving object, the orientation of direction 1002 may change with respect to the world or the environment in which the system is located, but does not change with respect to transceiver 110. And because it is preferable to maintain a fixed orientation as between transceiver 110 and enclosure 108, it is preferable that the orientation of direction 1002 not change with respect to enclosure 108. For example, if system 1000 is mounted upon an automobile and reference Direction 1002 is oriented to be facing the forward direction of travel of the automobile, reference direction 1002 may change with respect to the world when the automobile turns around corners while driving, but reference direction 1002 will remain fixed with respect to enclosure 108 and transceiver 110. The system disclosed herein will primarily be described with respect to providing a relative location of an object based on the angle and distance of the object with respect to the reference direction 1002 and a location of the inventive system 1000. However, the invention herein may be extended by allowing computation of the location of objects with respect to a different frame of reference while the system 1000 is moving or turning, or both, without departing from the substance of the invention described herein.

Also depicted in FIG. 10 is a direction of rotation 1008. In this example, direction of rotation 1008 is indicated to be counterclockwise, when viewed from above the system. However, the system may be implemented with a clockwise direction of rotation. Without departing from the principles described herein, the system may be implemented with a sweeping rotation that proceeds in alternating clockwise and counterclockwise directions over a predetermined number of degrees, a random number of degrees, a number of degrees determined by an area in the field of vision where an object was located or where an object was not located, an area based upon direction of travel or speed of travel, or numerous other parameters that may be set prior to deploying the system or even while the system is in operation. For example. If system 1000 is mounted on an unobstructed or minimally obstruction location on a vehicle that is moving slowly, it may be desirable to sweep a full 360° and continue rotating in the same direction. In another example, where the system 1000 is on a vehicle moving slowly, it may be desirable to sweep only a particular number of degrees in the forward direction of the vehicle such that it can determine whether a clear path forward exists. The angular width of the sweep in degrees might be determined by the width of the vehicle on which (or object on which) system 1000 is mounted. For example, if system 1000 is mounted on a bicycle, a narrow sweep may be sufficient to ensure a clear path moving forward in a straight path. In the alternative, if system 1000 is mounted on a large diesel truck, it may be necessary to sweep a broader path to determine whether a clear path forward exists. A train that cannot turn off of a track might require only a narrow sweep that might be narrowed even further if the train is moving through a tunnel. If the vehicle on which system 1000 is mounted is moving quickly, a narrow sweep forward might be sufficient to determine whether the path forward is clear or not, because the relative speed of the vehicle with respect to other expected objects in the vicinity may be sufficiently high that one would not expect another object to move into the path of the vehicle, whereas if the vehicle is moving relatively slow with respect to other objects in the vicinity, a wider sweep in the forward direction might be necessary to ensure a path forward or to avoid the possibility of objects moving into the path of the vehicle. In alternative embodiments, it might be desirable to configure the system to focus on a detected object that is moving in the field of view of system 1000. For example, if the system begins sweeping counterclockwise and encounters an object, it might be desirable to continue sweeping counterclockwise until the both the beginning edge and ending edge of the object is detected, and then reverse the sweep into the clockwise direction to detect the object again without waiting for an entire 360 degree rotation. And then, after the object is passed by the sweep, the sweep direction can be reversed again to detect the object again in a manner that may permit keeping a particular object within view of the sensor more consistently than would occur if the housing 230 were rotated in complete 360° rotations or relatively long sweeps of 180° or 120°, for example. In some instances, it may be desirable to sweep in the direction of travel, a direction that might change for the vehicle on which system 1000 is mounted without changing the orientation of reference direction 1002. For example, some robotic mechanisms have an ability to move forward, then cease forward movement and begin moving at a 90° angle to the side or at another angle without changing the orientation of the frame or body on which system 1000 might be mounted. As one example, if system 1000 is mounted on a humanoid robotic device that moves forward in the direction of reference direction 1002, stopping when it encounters an obstacle and, rather than turning, the robotic system side-steps or slides to the side while maintaining the same frame orientation, it may be desirable to configure system 1000 to sweep the forward direction primarily in the direction of reference direction 1002 until the robot ceases moving in that direction. And when the robot is ready to proceed in a direction that is, for example, 90° offset from direction 1002, to direct the system to begin sweeping in that 90° offset direction and to perform an alternating sweep back and forth that will determine whether objects are present in that 90° offset direction. When doing so, it may be necessary to move from a broad back-and-forth sweep to a narrow back-and-forth sweep, or vice versa, to maintain timeliness and efficiency in the system and in the manner in which sweeps are accomplished.

FIG. 10 further depicts a cone 1006 that is a representation of a potential spread of ultrasonic pulses that may be emitted from the mouth defined by toroidal rim 250 after the pulses have travelled in direction 1004 through cavity 248 of horn 102. The depicted cone 1006 is provided merely in an exemplary fashion and is not intended to indicate the actual breadth or width that the pulses may spread on emission from the horn 102, but rather to indicate that it is expected that there will be some spread as ultrasonic pulses are emitted from the horn 102. The shape and length of the waveguide and walls within horn 102 will determine the form of cavity 248, which will impact the manner in which ultrasonic pulses spread as they are emitted from the mouth defined by toroidal rim 250. It's expected that ultrasonic echoes will return in a direction roughly opposite to the direction indicated by 1004 and move roughly along axis 242 (as indicated in FIG. 2) before being deflected downward and into port 112 of transceiver 110.

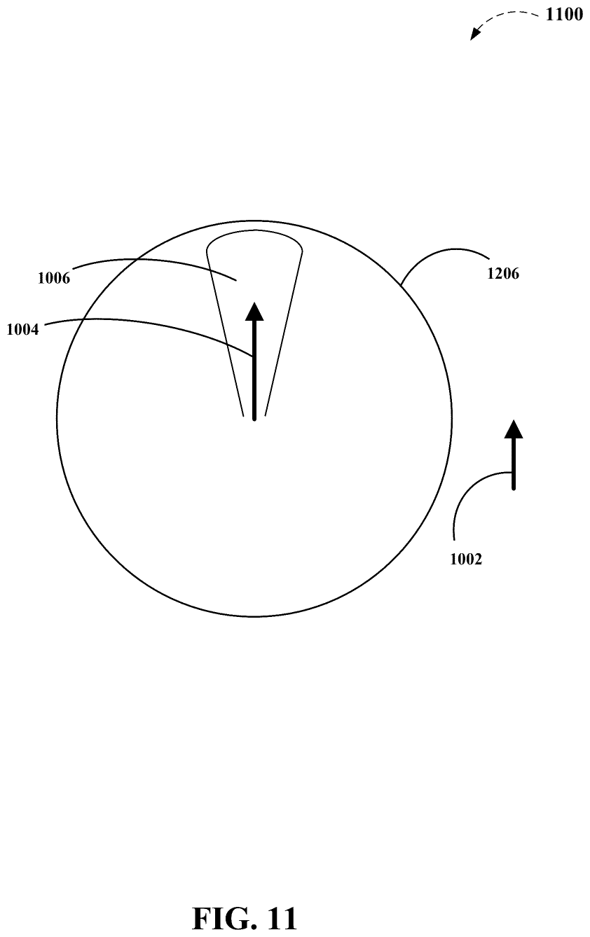

Referring to FIG. 11, a system 1100 corresponding to a potential display for scanning and position data is depicted that is used primarily for exemplary purposes in this disclosure, but which might also form a representation that is desirable to use and to display to a user in various embodiments of the inventive system. Scanning display 1206 is represented as a circular display with a reference direction 1002 that corresponds to the same reference direction of system 1000. The indicated direction 1004 indicates the direction in which the scanning system 1000 is currently emitting or will emit pulses if pulses from horn 102, if such pulses are emitted before the horn 102 is rotated to another position. The indication cone 1006 is intended to indicate a hypothetical expected spread of such pulses. A display such as display 1206 may take a familiar format of a rotating display such as a radar display or other displays in which a sensor beam is directed in a single direction and then scanning occurs while the beam is rotated about a center point. As indicated in the preceding discussion, there are many manners in which the system 1000 may be configured such that the housing 230 rotates about a 360° circle or rotates or scans across a smaller portion of such a circle. In the latter such arrangements, a display similar to display 1206 may be used. Or a display 1206 could be configured to correspond only to the portion of the circular field of view in which the pulses emerging from housing 230 are actually rotated.

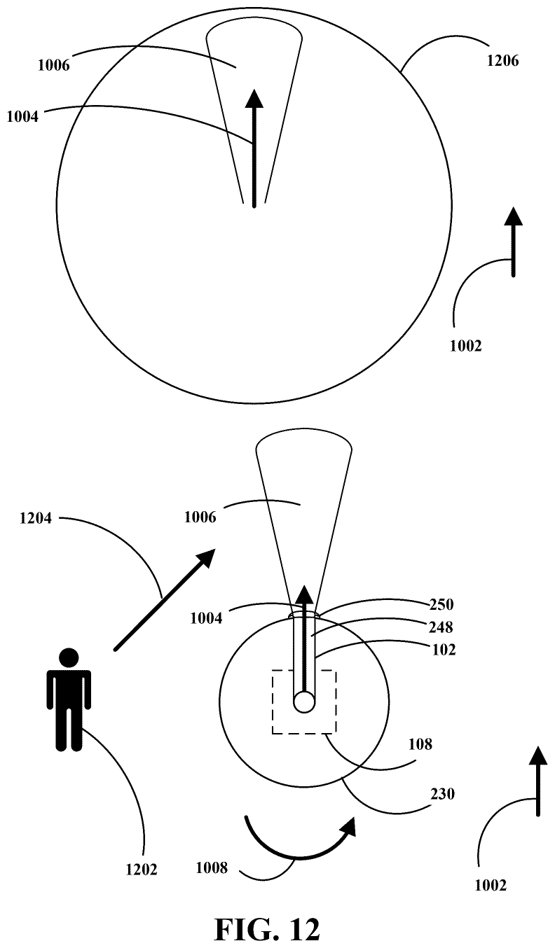

FIGS. 12-17 each depict a representation of housing 230 and a representation of a potential display 1206, as the housing 230 rotates in the direction 1008 and detects one or more objects in the course of rotation. FIGS. 12-17 are intended to represent a series of sequential states that occur in sequence to present a hypothetical use of the inventive system and method.

At the beginning of the rotation, in the exemplary FIG. 12, the direction in which pulses are emitted 1004 corresponds to direction 1002 and is offset by 0°. There is no need to initiate operation of the system in such alignment, and this particular alignment is provided merely as an example. An object 1202 is depicted with a humanoid form and is offset approximately 90° from sensor with respect to the direction of pulse emission 1004. The object's direction of travel is indicated by arrow 1204. At this point, as indicated on display screen 1206, the object 1202 has not yet been detected by the inventive system.

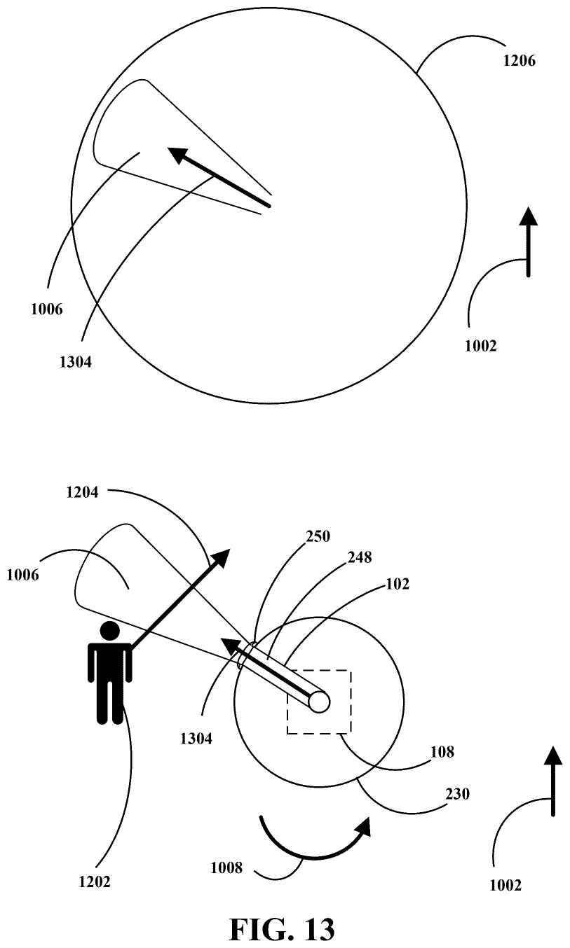

Proceeding to FIG. 13, which represents a later time, the object 1202 has slightly moved in the direction of travel 1204 while housing 230 and pulse emission direction 1004 have rotated counterclockwise approximately 60° from the position depicted in FIG. 12. If the housing is rotating at a 1 Hz speed (i.e., 1 second for a full rotation), for example, this would represent a gap of approximately ⅙ second between the representation of FIG. 12 and the representation of FIG. 13. Alternatively, if the rotation is a ⅓ Hz speed (i.e., 3 seconds for a full rotation), for example, this would represent a gap of approximately ½ second between the representation of FIG. 12 and the representation of FIG. 13. Various speeds of rotation may be employed without departing from the spirit of the invention. It is even possible to vary the speed of a scanner and even to vary the speed within a single rotation or within every rotation. It may be desirable to initiate operation with a single high speed 360 degree scan to obtain an initial rough reading of any nearby obstacles, before reverting to a slower and potentially more accurate scan speed. Or it may be desirable to scan slowly across the portion of the field of view in the direction of travel of a vehicle to which the system 1000 is connected and then scan quickly across the remaining portion of the field of view that may represent objects that the vehicle is moving alongside or away from, but not toward.

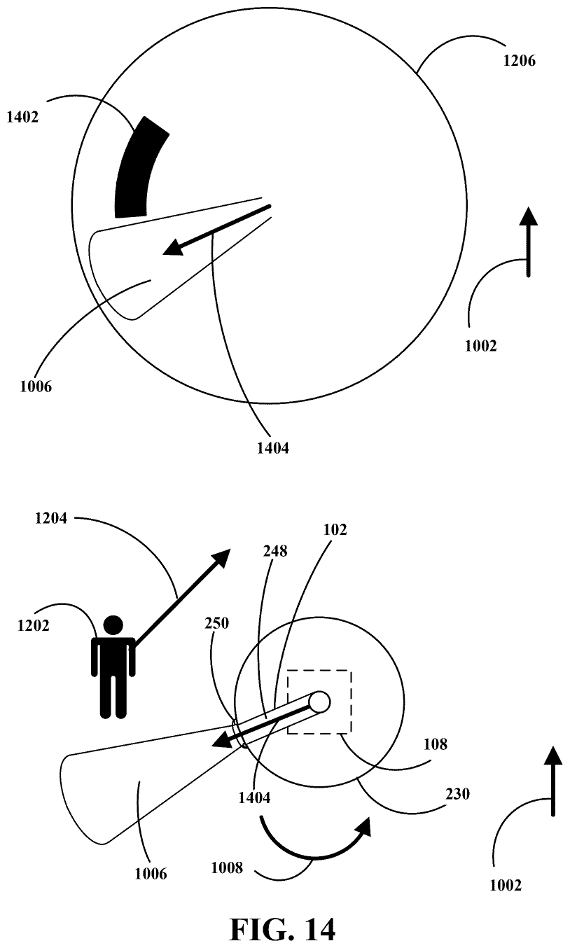

Proceeding to FIG. 14, the object 1202 has moved slightly and the beam of ultrasonic pulses has swept past the object 1202 such that the direction of pulse emissions is represented by direction 1404. Direction 1404 is offset approximately 120° from reference direction 1002. Having detected object 1202 which is slowly traveling in direction 1204, a representation 1402 of ultrasonic echoes received is indicated on display 1206. As noted in the discussion of the preceding figures, the display is not necessary for functioning of the inventive system and is primarily intended to represent what data may be used to display with respect to a detected object. The data represented by arcuate section 1402. Indicates that an object was detected at a certain distance from the sensor system 1000 and that the object spans a particular number of degrees of the field of view of the sensor system 1000. The edges of object 1402 are depicted as solid, but it is expected that edges of 1402 may have fuzzy data or less determinative data such that a representation of an object's center may be more defined than the edges of the representation. Also, the position of arcuate element 1402 in display 1206 may be used to indicate a distance from the sensor system 1000. For example, if representation 1402 was moved to the left and was adjacent to or partially beyond the circle defining the exterior edge of display 1206, that position might indicate that an object is at the edge of the range in which the system 1000 can detect objects. Alternatively, if representation 1402 was moved towards the center of display 1206, such position might be used to indicate that representation 1402 is closer to the sensor system 1000. One might expect that in many objects, as the object moves closer to the sensor, it will fill a larger percentage of the field of view of the sensor and, thus, be represented by an indication that spans a larger percentage of the circular field of view.

At this point depicted in FIG. 14, having detected object 1202, in certain systems, it may be desirable to have configured (or to send a command to) the system 1000 to reverse the direction of motor 406 and sweep the ultrasonic pulses back across the object in an effort to maintain a closer observation of the object and whether it is moving, and to detect such movement relative to the sensor 1000 or to the larger system (e.g., a vehicle or robot) on which the sensor may be mounted.

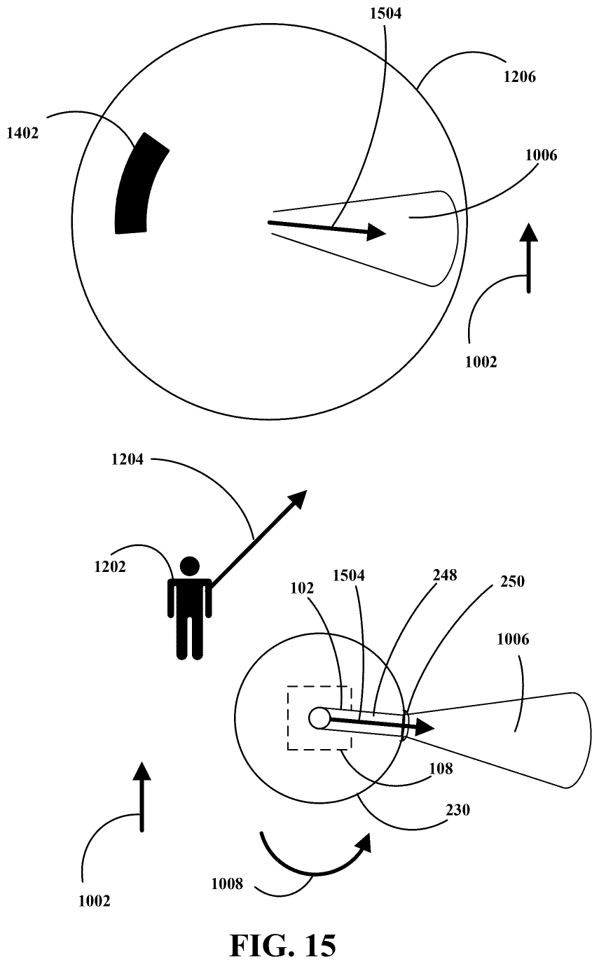

Turning to FIG. 15, the object 1202 continues to move in direction 1204 while the beam of ultrasonic pulses 1006 continues to sweep in a counterclockwise direction 1008. At this point in time, object 1202 is no longer in the previously detected position, but screen 1206 continues to indicate the detected position 1402 because the ultrasonic pulse beam 1006 has not yet swept over the object 1202 again. It can be seen that the beam direction 1504 is now offset by approximately 260° of counterclockwise rotation from reference direction 1002.

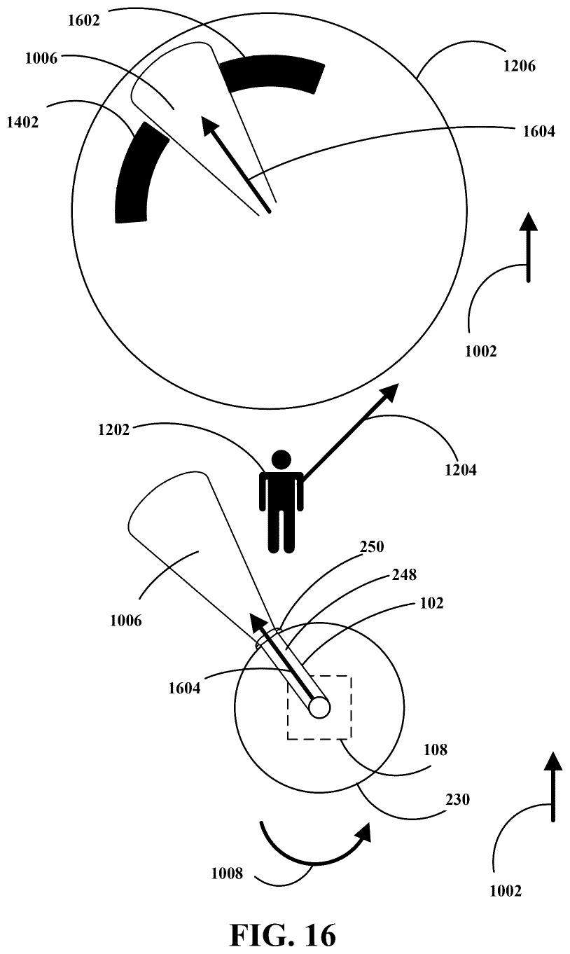

In FIG. 16, the beam has continued to sweep in a counterclockwise direction beyond reference direction 1002, such that the beam direction 1604 is now approximately 30° of counterclockwise rotation beyond reference direction 1002. The beam 1006 has swept past the new position of object 1202, while object 1202 that continues to move in direction 1204. But the beam has not yet swept into the area of the location where object 1202 was originally encountered on the prior sweep. Thus, as can be seen on display 1206 of FIG. 16, a second arcuate indication of an object is labeled as representation 1602. It may not yet be clear to a system or to an operator whether representation 1602 and representation 1402 represent the same object 1202 or different objects, so both 1402 and 1602 may be displayed on the screen as existing objects, even though the two representations 1402 and 1602 are known to the reader to represent different positions of the same moving object 1202.

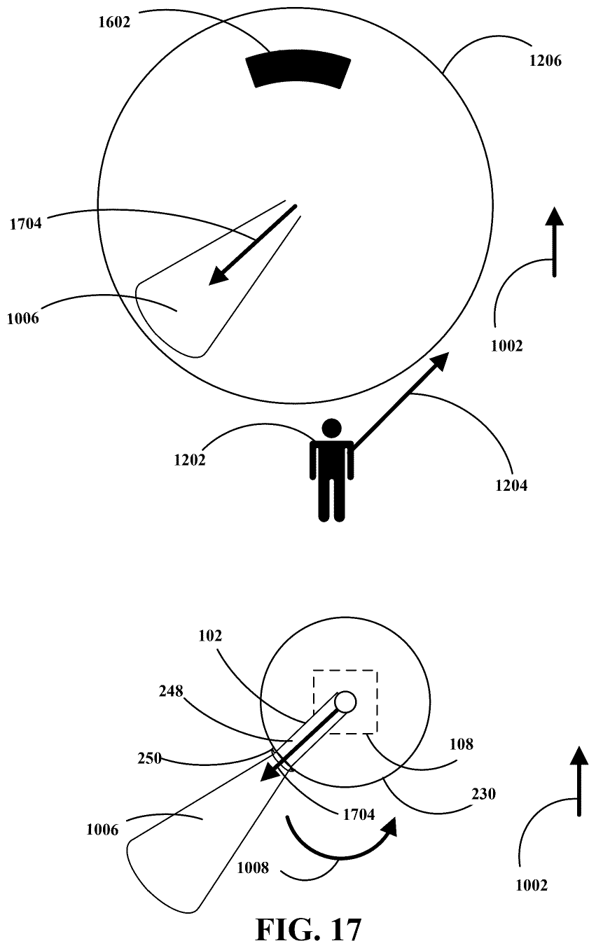

In FIG. 17, the ultrasonic pulse beam 1006 emission direction has now swept into direction 1704 which is approximately 135° offset in a counterclockwise direction from reference direction 1002. The beam 1006 has now swept past the location where indication 1402 was placed and has not detected an object by return echoes in the position or direction where object 1202 was initially detected such that display 1206 is now updated to show only a last sensed object, indicated by arcuate representation 1602. Object 1202 continues to move in direction 1204 and may move into another position or even out of the range of the sensor before the next sweep brings the beam 1006 into an angular position where object 1202 can be detected. As can be seen, by comparing FIG. 16 and FIG. 17, a moving object might appear as indications of two potential objects at certain times in the period in which housing 230 is completing a 360° sweep or a shorter alternating sweep. But in most instances, the ghost image from a previous position of an object will be eliminated after the beam 1006 of pulses being omitted from horn 102 sweeps past the old position.

As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. In addition, the word “coupled” is used herein to mean direct or indirect electrical or mechanical coupling. In addition, the words “example” and/or “exemplary” are used herein to mean serving as an example, instance, or illustration. Any aspect or design described herein as “example” and/or “exemplary” is not necessarily to be construed as preferred or advantageous over other aspects or designs. Rather, use of the word exemplary is intended to present concepts in a concrete fashion.

What has been described above includes examples of the subject disclosure. It is, of course, not possible to describe every conceivable combination of components or methodologies for purposes of describing the subject matter, but it is to be appreciated that many further combinations and permutations of the subject disclosure are possible. Accordingly, the claimed subject matter is intended to embrace all such alterations, modifications, and variations that fall within the spirit and scope of the appended claims.

In particular and in regard to the various functions performed by the above-described components, devices, systems and the like, the terms (including reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter.

The aforementioned systems have been described with respect to interaction between several components. It can be appreciated that such systems and/or components can include those components or specified subcomponents, some of the specified components or subcomponents, and/or additional components, and according to various permutations and combinations of the foregoing. Subcomponents can also be implemented as components communicatively coupled to other components rather than included within parent components (hierarchical). Additionally, it should be noted that one or more components may be combined into a single component providing aggregate functionality or divided into several separate subcomponents, and any one or more middle layers, may be provided to communicatively couple to such subcomponents in order to provide integrated functionality. Any component described herein may also interact with one or more other components not specifically described herein.

In addition, while a particular feature of the subject disclosure may have been disclosed with respect to only one of the several implementations, such feature may be combined with one or more other features of the other implementations as may be desired and advantageous for any given or particular application. Furthermore, to the extent that the terms “includes,” “including,” “has,” “contains,” or variants thereof, and other similar words are used in either the detailed description or the claims, these terms are intended to be inclusive in a manner similar to the term “comprising” as an open transition word without precluding any additional or other elements.

What is claimed is:

1. A system, comprising:
a rotatable bent horn having a mouth opening providing a field of view when rotated, a throat opening, and a waveguide;
the waveguide configured to (a) redirect a plurality of ultrasonic pulses received in the throat opening from a first axis of travel to a second axis of travel prior to emission from the mouth opening and (b) redirect one or more ultrasonic echoes received in the mouth opening from a third axis of travel to a fourth axis of travel prior to emission from the throat opening;
the first axis being at an angle to the second axis;
means for rotating the horn about an axis of rotation substantially parallel to the first axis while maintaining the first axis within the throat opening, such that the plurality of ultrasonic pulses may be received by the throat opening and the one or more ultrasonic echoes may be emitted from the throat opening while at least a portion of the mouth opening traverses a substantially circular arc-shaped path, the path lying substantially on a plane perpendicular to the axis of rotation.

2. The system of claim 1, further comprising:
an ultrasonic transceiver, configured to transmit ultrasonic pulses and receive ultrasonic echoes;
the transceiver positioned near the throat opening such that a substantial portion of the ultrasonic pulses transmitted by the transceiver will be directed into the throat opening and one or more resulting ultrasonic echoes will be received by the transceiver from the throat opening;
the transceiver further arranged to maintain a substantially fixed position with respect to rotation about the axis of rotation when the horn is rotated about the axis of rotation.

3. The system of claim 2, wherein
the transceiver is disposed such that at least a portion of the ultrasonic pulses to be emitted by the transceiver will travel into the throat opening along one or more axes that are substantially parallel to the first axis, and at least a portion of the one or more resulting ultrasonic echoes will travel to the transceiver along one or more axes that are substantially parallel to the fourth axis.

4. The system of claim 1, wherein
the first axis of travel is substantially perpendicular to the second axis of travel, and
the third axis of travel is substantially perpendicular to the fourth axis of travel.

5. The system of claim 1, wherein the means for rotating the horn comprises:
a motor; and
at least one gear to rotate the horn by receiving a force input from the motor.

6. The system of claim 5, wherein:
the motor is configured to provide an angle of rotation to a processor, wherein the angle of rotation relates to an angle of the horn's rotation.

7. The system of claim 2, further comprising:
a processor for receiving data regarding angle of rotation at various times and for receiving sensor data regarding ultrasonic echoes;
wherein the means for rotating the horn comprises a motor configured to provide angle of rotation data to the processor; and
wherein the transceiver is configured to provide sensor data regarding ultrasonic echoes to the processor.

8. The system of claim 7, wherein:
the processor is configured to process the angle of rotation data and the sensor data to detect and locate objects in proximity to the horn.

9. The system of claim 8, wherein:
the motor is configured to rotate the horn in an oscillating manner about the axis of rotation such that the horn rotates less than 360 degrees about the axis of rotation before reversing the direction of rotation.

10. A method for scanning an arcuate field of view comprising:
in a plane perpendicular to an axis of rotation and having a reference direction within the plane, rotating at least a portion of a mouth of a horn along a substantially arcuate path in the plane, wherein each point of the substantially arcuate path is substantially equidistant from the axis of rotation;
emitting a plurality of ultrasonic pulses from the mouth;
receiving at least one ultrasonic echo with the mouth;
determining a location of an object based at least upon an angular position of the mouth with respect to the reference direction, when the at least one ultrasonic echo is received.

11. The method of claim 10, further comprising:
receiving a plurality of ultrasonic echoes with the mouth; and
determining the location of a plurality of objects based at least upon a plurality of angular positions of the mouth when the plurality of ultrasonic echoes are received,
wherein the angular positions are defined by reference to the reference direction.

12. The method of claim 10, further comprising, prior to emitting each ultrasonic pulse from the mouth:
transmitting the ultrasonic pulse from an ultrasonic transceiver whose transmitter is oriented to transmit pulses in a first direction substantially parallel to the axis of rotation;
receiving the ultrasonic pulse in a throat of the horn; and
redirecting the ultrasonic pulse within a waveguide of the horn, such that a substantial portion of the energy of the ultrasonic pulse is redirected into a second direction.

13. The method of claim 10, further comprising, after receiving each ultrasonic echo with the mouth:
redirecting the ultrasonic echo within a waveguide of the horn, such that a substantial portion of the energy of the ultrasonic echo is redirected into a first direction substantially parallel to the axis of rotation;
emitting the ultrasonic echo from a throat of the horn; and
receiving the ultrasonic echo with an ultrasonic transceiver whose receiver is oriented to receive pulses traveling in the first direction.

14. The method of claim 10, wherein:
the mouth of the horn is rotated by a motor mechanically attached to the horn.

15. The method of claim 14, the method further comprising:
providing an angle of rotation to a processor, wherein the angle of rotation relates to an angle of the horn's rotation.

16. The method of claim 14, further comprising, for each ultrasonic echo received:
receiving with a processor, an angle of rotation that corresponds to a time that the ultrasonic echo was received; and
using travel time of the ultrasonic echo and the angle of rotation to determine the location of at least one object.

17. The method of claim 14, further comprising:
reversing direction of the motor before the substantially arcuate path traverses 360 degrees about the axis of rotation.

18. A non-transitory machine-readable medium, comprising executable instructions that, when executed by a device comprising a processor, facilitate performance of operations comprising:
emitting a plurality of ultrasonic pulses from an ultrasonic transceiver that is fixed with respect to an axis of rotation;
causing a motor to rotate a bent horn such that at least a portion of the mouth of the bent horn rotates in a substantially arcuate path about the axis of rotation;
receiving echo data corresponding to the receipt of a plurality of ultrasonic echoes by the ultrasonic transceiver through the bent horn; and
receiving angular data corresponding to the angles of rotation of the bent horn when each of the plurality of ultrasonic echoes is received by the ultrasonic transceiver.

19. The non-transitory machine-readable storage medium of claim 18, the operations further comprising:
calculating the location of one or more objects based on the received echo data and the received angular data.

20. The non-transitory machine-readable storage medium of claim 18, the operations further comprising:
causing the motor to reverse directions after the mouth of the bent horn has traveled in the substantially arcuate path for less than 360 degrees about the axis of rotation.
